(19) United States
(12) Patent Application Publication
(10) Pub. No.: US 2013/0252542 A1
(43) Pub. Date: Sep. 26, 2013

(54) RADIO-FREQUENCY INDUCTION SYSTEM WITH INTERACTIVE FUNCTIONS

(71) Applicants: Cheng-Tsung TSAI, New Taipei City (TW); Chen-Hung Hsieh, Taipei (TW); Chien-Wei Huang, New Taipei City (TW)

(72) Inventors: Cheng-Tsung TSAI, New Taipei City (TW); Chen-Hung Hsieh, Taipei (TW); Chien-Wei Huang, New Taipei City (TW)

(21) Appl. No.: 13/428,672

(22) Filed: Mar. 23, 2012

(51) Int. Cl. H04B 5/00

(52) U.S. Cl. 455/41.1

(57) ABSTRACT

This invention relates to an RF induction system with interactive functions and an induction device for the same. The RF induction system has an induction device, an electronic device, a card reader and an application server, wherein the induction device is mounted on a carrier which has an electronic tag and a modulation module; a headset input interface (jack socket) connects between the electronic device and the modulation module connecting to an RF micro-controller of the electronic tag. When the electronic tag approaches to the card reader, digital information is processed and modulated to a audio signal via a headset output interface (jack plug) to be outputted to the electronic device which has the headset input interface (jack socket). When users use the electronic tag for induction, the electronic device interacts to the application server by a network for diversified applications.

### BACKGROUND OF THE INVENTION

1. Field of the Invention

This invention relates to a radio frequency (RF) induction system, especially with interactive functions, wherein an induction device can connect to a personal electronic device that has a headset output interface (jack plug) connecting to applications of a personal electronic device.

2. Description of Related Art

Radio Frequency Identification (RFID) and Near Field Communication (NFC) are popular induction techniques of wireless non-contact system, wherein the RFID technique has three types: active, semi-passive and passive. The NFC is developed according to the RFID techniques. In this field, the passive type, i.e. electronic tag, can be used in a variety of applications.

With reference to FIG. 6, a current RF induction system has an electronic tag 70, a card reader 80 and an application server 90. The electronic tag 70 includes an RF micro-controller 71 (the RFID technique uses the RFID micro-controller, and the NFC technique uses NFC micro-controller), an antenna 72, and an encoder 73. The RF micro-controller 71 connects to the antenna 72 and the encoder 73. The encoder 73 with memory stores digital information such as an identification code. The card reader 80 connects to the application server 90, and keeps emitting an electromagnetic radiation. When the electronic tag 70 approaches the card reader, an electric current will be induced on the antenna 72 of the electronic tag 70 by the electromagnetic radiation to drive the RF micro-controller 71 to access the digital information of the encoder 73. The antenna 72 responses a radio waves to the card reader 80 according to the digital information. After the card reader 80 gets and decodes the digital information, the digital information will be sent to the application server 90.

The RFID and the NFC techniques are used in commercial applications. The electronic tag 70 is mounted on a carrier such as a card that can be a membership card, a security card, a stored-value card, etc. Users can take the card to approach the card reader 80 to identify membership, set up or access service, and store value by the application server 90.

As stated above, the internal information of the electronic tag is only accessed nearby the card reader. For payment application, users are limited to get amount of the stored-value card only by the card reader. Until the card reader warns that the amount is not enough, users cannot be informed to store value. Because the internal information of the electronic tag is invisible, this inconvenient situation still exists.

Users only have cards with the electronic tag, but the card reader is the only way to communicate between the electronic tag and an electronic device which connects to the application server, so users only can transmit the data to the application server by a single way. Service companies cannot build up an interactive network communication relation with users. For example, service companies cannot offer multimedia advertisements or digital information to users; users also cannot use the electronic tag via network applications and the application server to accomplish an identification action.

To summarize, the current RF induction system for users is inconvenient. A service end of the RF induction system cannot communicate with customers for satisfying usage requirements of service companies and customers, so the current RF induction system needs to be improved.

### SUMMARY OF THE INVENTION

This invention relates to an RF induction system and an induction device with interactive functions. To approach the purpose, the RF induction system includes:

the induction device having a carrier, an electronic tag, a modulation module and a headset output interface (jack plug); wherein

the electronic tag is mounted on the carrier and has an RF micro-controller, an encoder and an antenna; the encoder with memory stores digital information; the RF micro-controller connects to the encoder and the antenna; when the antenna receives an electromagnetic radiation, the RF micro-controller is driven to get the digital information from the encoder; the digital information is encoded to an RF signal and responded by the antenna;

the modulation module is mounted on the carrier and connected to the RF micro-controller of the electronic tag; the output digital information of the RF micro-controller is modulated to a audio signal to be outputted;

the headset output interface (jack plug) connects to the modulation module for outputting the audio signal;

an electronic device has a headset input interface (jack socket) which connects to the headset output interface (jack plug) of the induction device, and the electronic device has a demodulation application which is corresponding to a modulation application of the modulation module for demodulating the audio signal outputted from the induction device to obtain the digital information;

a card reader emits the electromagnetic radiation to drive the RF micro-controller of the electronic tag, receives the RF signal of the induction device to process the digital information that is accessed, and outputs the digital information; and

an application server connects to the card reader for receiving the digital information, and connects to the electronic device via the Internet for communicating with the electronic device.

When the induction device communicates with the card reader, the digital information will be transformed to the RF signal and responded to the card reader. At that moment, the modulation module will transform the digital information to the audio signal for the electronic device of the headset input interface (jack socket) such as mobile phones and tablet personal computers. The electronic device of a user end and the application server both can receive the digital information of the electronic tag. Thus, service companies can offer a application of the electronic device which is downloadable to communicate the electronic device to the application server; for example, the electronic device transmits a personal password or a signature to the application server for identification by a network, or the application server transmits amount of a stored-value card to the electronic device by the network. By this way, users can know the digital information of the electronic tag by a personal electronic device; on the other hand, the users can interact with the service end by the electronic device. In the hardware system condition of this invention, the RF induction system provides the application server software and electronic device software to extend various services.

For the purpose of achieving this invention, the induction device comprises a carrier, an electronic tag, a modulation module and a headset output interface (jack plug).

The electronic tag is mounted on the carrier and comprises an encoder, an antenna and an RF micro-controller. The encoder with memory stores digital information. The antenna is for receiving an electromagnetic radiation. The RF micro-controller is connected to the encoder and the antenna, driven to access the digital information in the encoder, converts the digital information to an RF signal, and responded to the RF signal via the antenna after the electromagnetic radiation is received by the antenna.

The modulation module is mounted on the carrier, connected to the RF micro-controller of the electronic tag, and modulates the digital information outputted from the RF micro-controller to a audio signal.

The headset output interface (jack plug) connects to the modulation module, and the audio signal is sent to the electronic device.

Currently different brands have different data input interfaces for the electronic devices, especially the smart phones, but most of the headset interfaces are standard, so in this invention, the digital information is modulated to the audio signal for a mobile phone which has a headset interface (jack plug) connecting applications of the induction device.

### BRIEF DESCRIPTION OF THE DRAWINGS

FIG. 1 is an electronic block diagram of this invention;

FIG. 2 is a schematic diagram of this invention;

FIG. 3 is a detail electronic diagram of an induction device of this invention;

FIG. 4 is an exploded plane diagram when this invention is applied to a smart phone;

FIG. 5 is a signal transmitting schematic diagram of FIG. 1; and

FIG. 6 is an electronic block diagram of a current RF induction system.

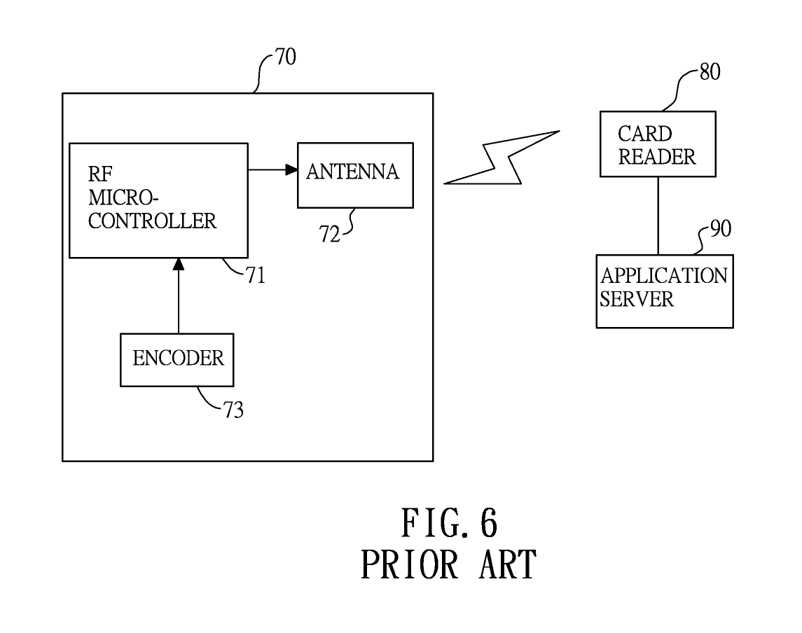

### DETAILED DESCRIPTION OF PREFERRED EMBODIMENT

An embodiment of the invention is as below, further describing how to approach the objective of the invention.

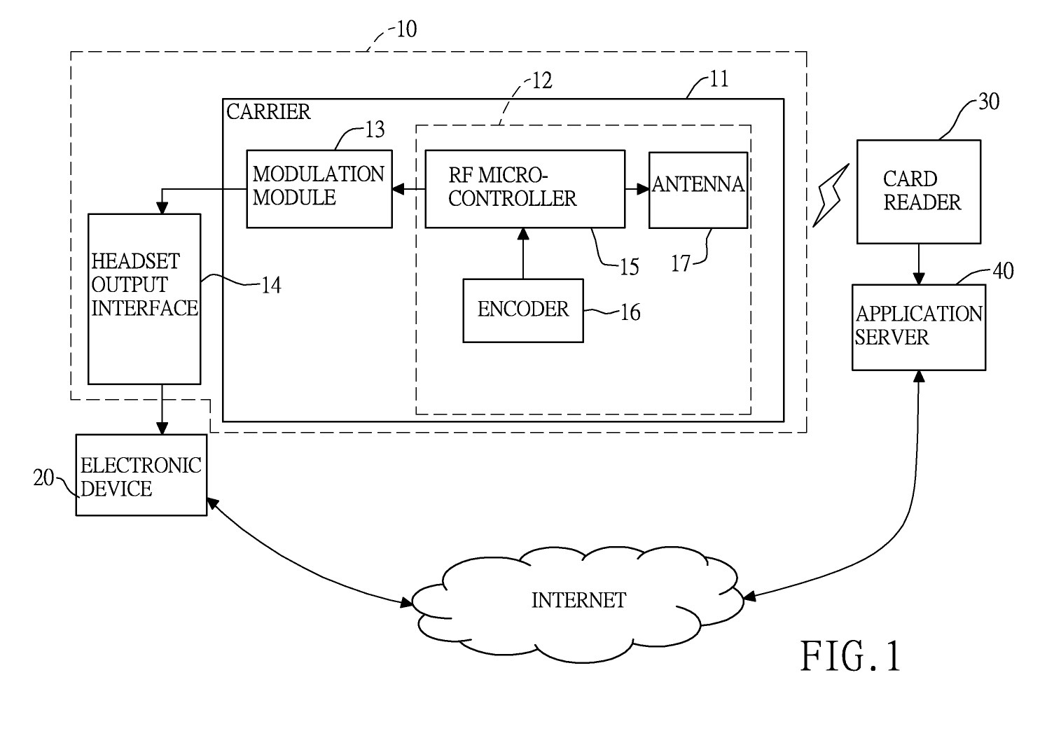

With reference to FIG. 1, an RF induction system with interaction functions of this invention includes an induction device 10, an electronic device 20, a card reader 30 and an application server 40.

The induction device 10 has a carrier 11, an electronic tag 12, a modulation module 13 and a headset output interface (jack plug) 14. The electronic tag 12 is mounted on the carrier 11 and includes an RF micro-controller 15, an encoder 16 and an antenna 17. The encoder 16 with memory stores digital information. The antenna 17 receives an electromagnetic radiation. The RF micro-controller 15 connects to the encoder 16 and the antenna 17. After the antenna 17 receives the electromagnetic radiation, the RF micro-controller 15 is powered by electromagnetic fields and driven the encoder 16 to encode an RF signal. The RF signal is responded by the antenna 17.

The modulation module 13 is mounted on the carrier 11 and connected to the RF micro-controller 15 of the electronic tag 12 and modulates the digital information outputted from the RF micro-controller 15 to an audio signal.

The headset output interface (jack plug) 14 connects to the modulation module 13 and outputs the audio signal.

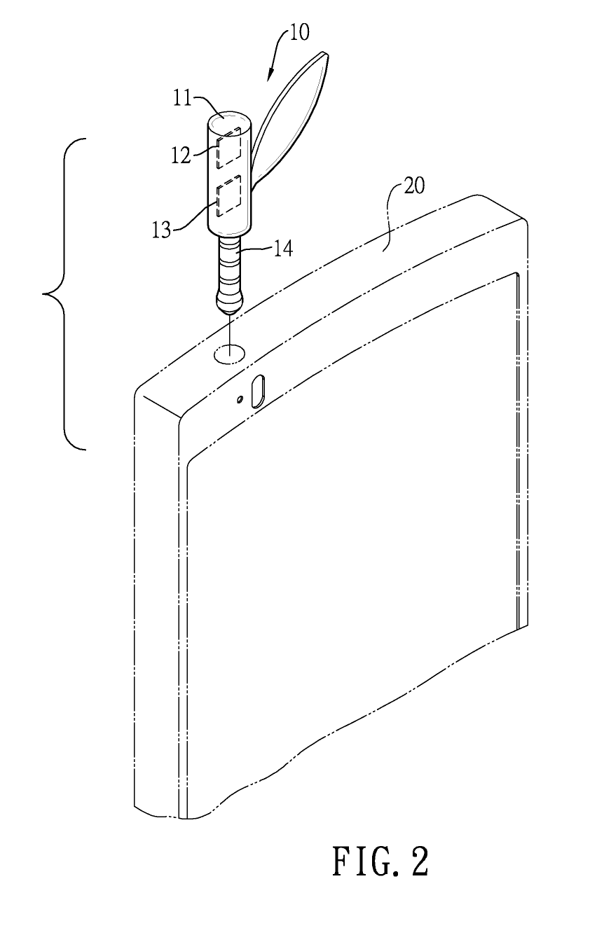

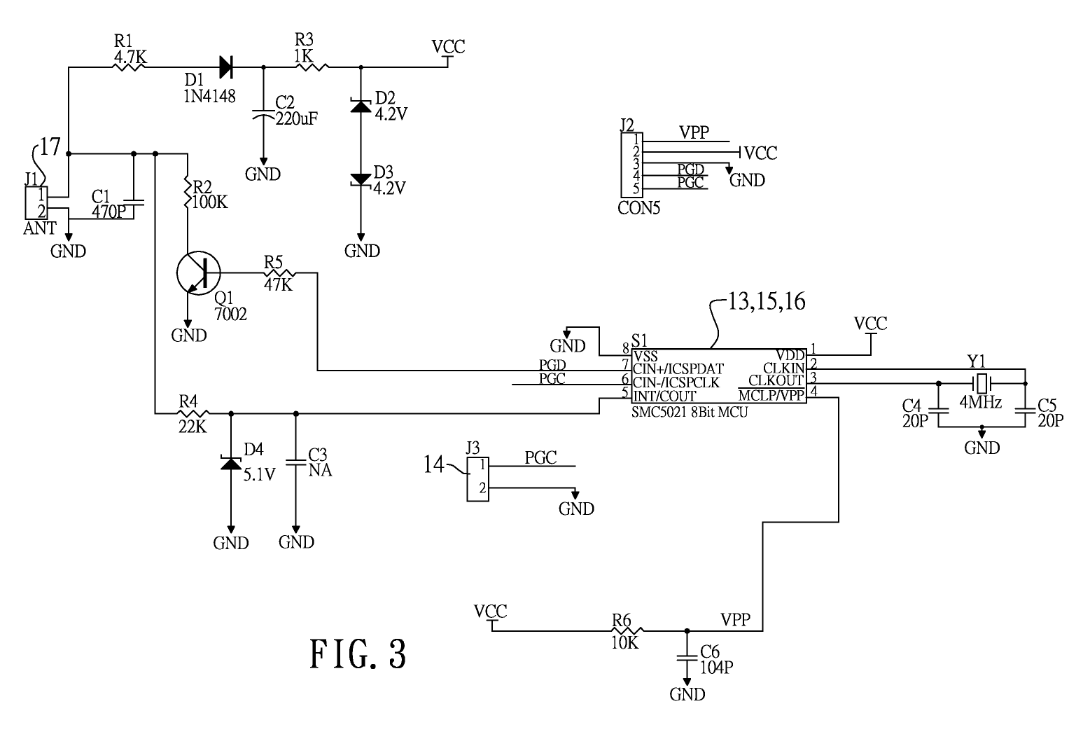

In this embodiment, the RF micro-controller 15 can be an RFID micro-controller or an NFC micro-controller to output the RF signal by an RF technique. The carrier 11 can be a card or a decoration as shown in FIG. 2, wherein the headset output interface (jack plug) 14 is mounted on the carrier 11. With reference to FIG. 3, the modulation module 13, the RF micro-controller 15, and the encoder 16 can be integrated into an SMC5021 micro controller unit (MCU).

The electronic device 20 has a headset input interface (jack socket), and connects to the headset output interface (jack plug) 14 of the induction device 10; the electronic device 20 also has a demodulation application which is corresponding to a modulation application of the modulation module 13 for demodulating the audio signal outputted from the induction device 10 to obtain the digital information; in this embodiment, the electronic device 20 can be a smart phone or a tablet personal computer.

The card reader 30 emits the electromagnetic radiation for driving the RF micro-controller 15 of the electronic tag 12, receives the RF signal of the induction device 10 to process the digital information, and outputs the digital information.

The application server 40 connects to the card reader 30 to receive the digital information and connects to the electronic device 20 via the Internet for communicating with the electronic device 20. The modulation module 13 and the demodulation application of the electronic device 20 can modulate and demodulate the digital information by an asynchronous transmission.

With reference to FIG. 2, the headset output interface (jack plug) 14 of the induction device 10 is a headset jack plug. The headset input interface (jack socket) of the electronic device 20 can be a headset jack socket. Because the headset jack socket is a standard specification for current mobile phones, the outer connection induction device can extensively apply to different types of smart phones.

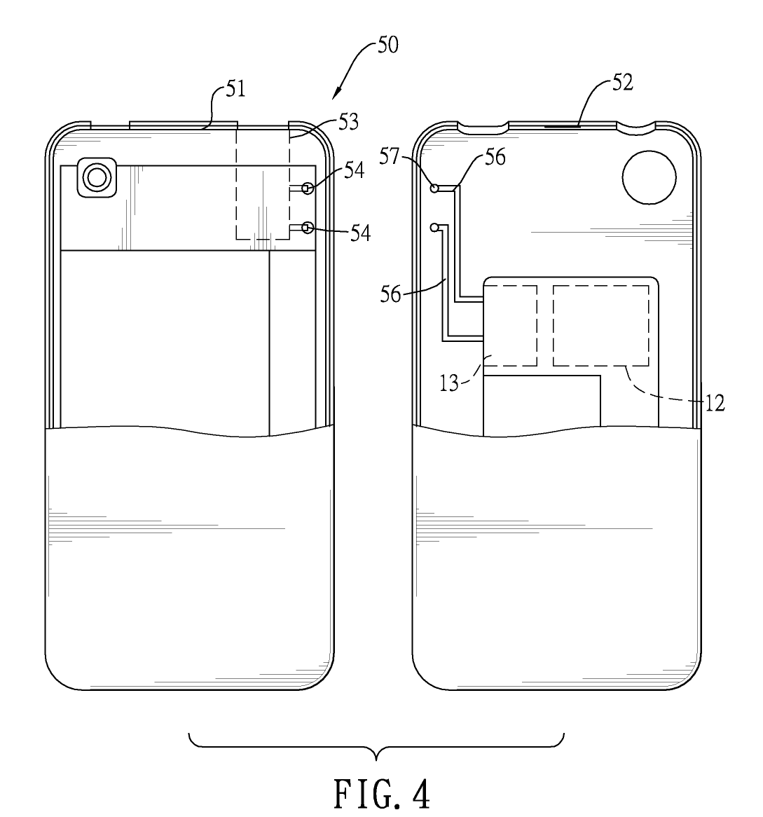

With reference to FIG. 4, when the induction device 10 is integrated into a smart phone 50, the smart phone 50 includes a phone body 51 and a back cover 52. The phone body 51 has a headset socket 53 which has two input contacts 54 that are exposed to a backside of the phone body 51 as the headset input interface (jack socket). The back cover 52 is located on the backside of the phone body 51. The electronic tag 12 and the modulation module 13 of the induction device 10 are embedded in the back cover 52. The back cover 52 can be a carrier and has two metal wire layers 56 formed on an internal surface which is opposite to the phone body 51. Each metal wire layer 56 has a convex metal point 57, wherein the convex metal points 57 touch the two input contacts 54 of the backside of the exposed phone body 51. Therefore in this method, the induction device 10 can be integrated into the smart phone 50 without changing internal circuits of the smart phone 50.

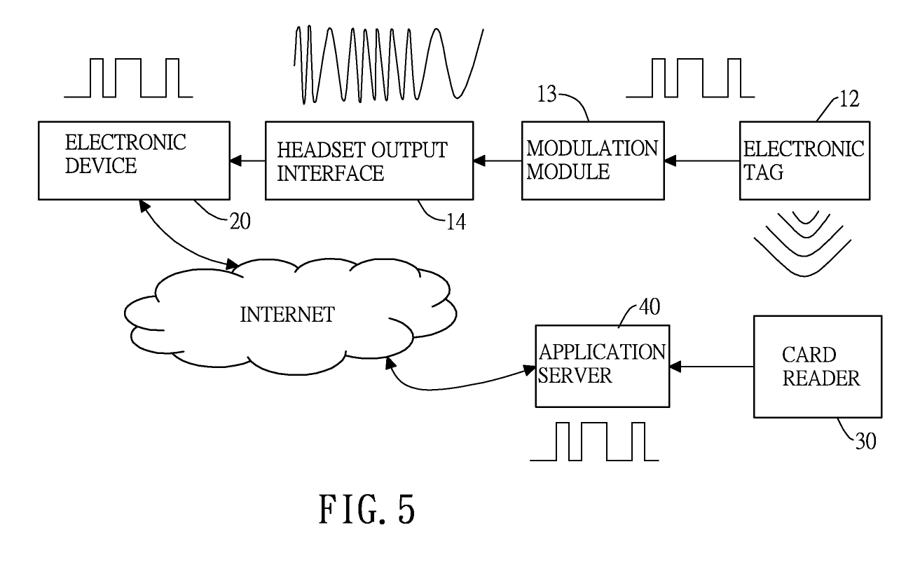

With reference to FIG. 5, when the induction device 10 is in use and the carrier approaches to the card reader 30, if the induction device 10 is integrated into the smart phone 50, the smart phone 50 approaches to the card reader 30, which will emit the electromagnetic radiation to the antenna 17 of the electronic tag 12. An electric current will be induced to drive the RF micro-controller 15 to access the digital information from the encoder 16. The antenna 17 responses the RF signal to the card reader 30 according to the digital information, and the card reader 30 can process the digital information of the RF signal. The RF micro-controller 15 will transmit the digital information to the modulation module 13. The digital information will be modulated to the audio signal by the modulation module 13 to be outputted to the electronic device 20 through the headset output interface (jack plug) 14. (If the induction device 10 is integrated into the smart phone 50, the smart phone 50 can be the electronic device 20.) The electronic device 20 can use the demodulation application to get original digital information. When the electronic tag 12 approaches the card reader 30 for induction, the application server 40 and the electronic device 20 both can receive the digital information, wherein the electronic device 20 transmits the network information to the application server 40 by the Internet. After building up the stated hardware system, according to the service characteristics, service companies provide different software to let users download to the electronic device 20. As for the current popular smart phones, users can use smart phones to download application and connect to the service end for having an interaction by the Internet. The invention can be applied for these potential perspectives, wherein

1. When the electronic tag 12 has a function as a stored-value card to pay or add value, the application server 40 stores the current value of the stored-value card into the electronic device 20 via the Internet. As using a smart phone, users can use the smart phone to check amount of the stored-value card by the Internet for easy management. For the payment by the stored-value card, the application server 40 demands verification to the smart phone via the Internet, and demands to enter a password or a digital signature. Financial institutions can demand verification for paying on the Internet by this way to prohibit the stored-value card from being embezzled when the card is lost; users are relieved to pay a big amount of money in business transactions.

2. The electronic device 20 demands the application server 40 to transmit an instant message; for example, setting the card readers 30 in exhibitions or bus stops, users use the electronic tags 12 to induct the card readers 30; the electronic device 20 demands the application server 40 to respond to multiple instant messages by the Internet; exhibition information or bus location can be shown to users by the application server 40 via the Internet transmitting the exhibition information or bus location information to the electronic device 20.

To summarize, the purpose of this invention is that the electronic tag can be used with the electronic device, so the invention not only can let users know digital information contents of the electronic tag by the electronic device, but users also can get the digital contents and interact with the service end by the Internet. Because smart phones are very popular, the headset input interface (jack socket) of smart phones is standard equipment. In this invention, the induction device uses the audio signal via the headset output interface (jack plug) to transmit the digital information of the electronic tag for smart phones which have the headset input interface (jack socket) and without using special function mobile phones. Mobile phone manufacturers also do not have to change internal circuits of mobile phones to be integrated into the back cover of phones, not only eliminating a defect that the current electronic tag cannot interact from service end to user terminal via the network, but service companies also can design application themselves for offering diverse services. In this way, a limited application of the RF induction system can be overcome, and this invention can extensively apply to diverse smart phones, so users do not have to buy special function mobile phones.

What is claimed is:

1. An RF induction system with interactive functions comprising:
an induction device comprising
a carrier;
an electronic tag mounted on the carrier and comprising
an encoder that stores digital information;
an antenna for receiving an electromagnetic radiation; and
an RF micro-controller connected to the encoder and the antenna, wherein the RF micro-controller is driven to process the digital information in the encoder, converts the digital information to an RF signal and responses the RF signal via the antenna after the electromagnetic radiation is received by the antenna;
a modulation module that is mounted on the carrier and connected to the RF micro-controller of the electronic tag and modulates the digital information outputted from the RF micro-controller to a audio signal; and
a headset output interface connected to the modulation module for outputting the audio signal;
an electronic device which is connectible to Internet and comprises
a headset input interface for connecting the headset output interface of the induction device; and
a demodulation application which is corresponding to a modulation application of the modulation module for demodulating the audio signal outputted from the induction device to obtain the digital information;
a card reader emitting the electromagnetic radiation to drive the RF micro-controller of the electronic tag, receiving the RF signal of the induction device, processing the digital information of the RF signal, and outputting the digital information; and
an application server connected to the card reader for receiving the digital information, and connected to the electronic device via the Internet for communicating with the electronic device.

2. The RF induction system as claimed in claim 1, wherein the headset output interface is a headset jack plug.

3. The RF induction system as claimed in claim 1, wherein
the electronic device is a smart phone;
the induction device is integrated into the smart phone which has a phone body and a back cover, wherein the phone body has a headset socket which includes two input contacts exposed on a backside of the phone body as the headset input interface;
the back cover is located on a backside of the phone body;
the electronic tag of the induction device and the modulation module are embedded into the back cover;
the back cover has two metal wire layers formed on an internal surface which is opposite to the phone body, wherein each metal wire layer has a metal convex point, and the two metal convex points are connected to the input contacts of the phone body.

4. The RF induction system as claimed in claim 1, wherein the RF micro-controller is an RFID micro-controller or an NFC micro-controller.

5. The RF induction system as claimed in claim 2, wherein the RF micro-controller is an RFID micro-controller or an NFC micro-controller.

6. The RF induction system as claimed in claim 3, wherein the RF micro-controller is an RFID micro-controller or an NFC micro-controller.

7. An induction device, comprising:
a carrier;
an electronic tag mounted on the carrier and comprising
an encoder that stores digital information; and
an antenna for receiving an electromagnetic radiation;
an RF micro-controller connected to the encoder and the antenna, wherein the RF micro-controller is driven to access the digital information in the encoder, converts the digital information to an RF signal and responds the RF signal via the antenna after the electromagnetic radiation is received by the antenna;
a modulation module that is mounted on the carrier and connected to the RF micro-controller of the electronic tag and modulates the digital information outputted from the RF micro-controller to a audio signal; and
a headset output interface connected to the modulation module for outputting the audio signal.

8. The induction device as claimed in claim 7, wherein in the modulation module, the RF micro-controller and the encoder are integrated into a micro controller unit.

9. The induction device as claimed in claim 7, wherein the headset output interface is a headset jack plug.

10. The induction device as claimed in claim 8, wherein the headset output interface is a headset jack plug.

11. The induction device as claimed in claim 7, wherein the carrier is a back cover of a smart phone, the electronic tag and the modulation module are embedded into the back cover, and the back cover has two metal wire layers formed on an internal surface, wherein each metal wire layer has a metal convex point, and the two metal convex points are the headset output interface.

12. The induction device as claimed in claim 8, wherein the carrier is a back cover of a smart phone, the electronic tag and the modulation module are embedded into the back cover, and the back cover has two metal wire layers formed on an internal surface, wherein each metal wire layer has a metal convex point, and the two metal convex points are the headset output interface.

13. The induction device as claimed in claim 9, wherein the RF micro-controller is an RFID micro-controller or an NFC micro-controller.

14. The induction device as claimed in claim 10, wherein the RF micro-controller is an RFID micro-controller or an NFC micro-controller.

15. The induction device as claimed in claim 11, wherein the RF micro-controller is an RFID micro-controller or an NFC micro-controller.

16. The induction device as claimed in claim 12, wherein the RF micro-controller is an RFID micro-controller or an NFC micro-controller.
